(19) United States
(12) Patent Application Publication
(10) Pub. No.: US 2026/0186883 A1
(43) Pub. Date: Jul. 2, 2026

(54) SCALABLE COUNTERS FOR BURSTY EVENTS INCLUDING CORRECTABLE ERRORS

(71) Applicant: Ampere Computing LLC, Santa Clara, CA (US)

(72) Inventors: Dave HARRIMAN, Portland, OR (US); Robert TOEPFER, Portland, OR (US)

(21) Appl. No.: 19/007,323

(22) Filed: Dec. 31, 2024

(51) Int. Cl. G06F 11/07

(52) U.S. Cl. CPC G06F 11/0769

(57) ABSTRACT

Disclosed are techniques for performing scalable counters-based event detection. In an aspect, a method for performing scalable counters-based event detection comprises receiving, at an event information collector, at least one event notification from an event source of a plurality of event sources. The at least one event notification may include an identification associated with the event source. The method may further include translating the at least one event notification into at least one remote atomic increment operation. The method may further include modifying, based on the at least one remote atomic increment operation, at least one counter value.

### BACKGROUND

### I. Field of the Disclosure

Aspects of the disclosure relate generally to computing systems, and specifically to error detection in computing systems.

### II. Background

With respect to computing systems, Peripheral Component Interconnect Express (PCIe) may be described as a high-speed interface standard that connects components such as graphics cards, sound cards, etc., to a motherboard. In PCIe, when an error is detected, a PCIe message may be sent to a host indicating a general type of the error, and an originating function and port for the error. Examples of types of errors may include correctable, uncorrectable, and fatal errors.

In some cases, software running on the host may be triggered via an interrupt to read registers in a root port. The software may log an error and, in some cases, schedule further error handling. This approach can include drawbacks such as increased system load of overhead processes to perform the error handling. Such an increase can utilize system resources (in one aspect, processing cores) that could otherwise perform other types of workloads. Another drawback may include overload of root port logging registers. For example, errors that are relatively infrequent can nevertheless occur in bursts (e.g., in one aspect, on the order of 100 million to 1 billion messages per second), and can overload root port logging registers. Yet another drawback relates to misattribution of the source of errors. For example, since PCIe hierarchies can vary from small to large, errors that are occurring in a remote subsystem can consume host resources while also leading to remote errors being misattributed as a host problem.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Scalable counters-based event detection apparatuses and methods for scalable counters-based event detection are disclosed herein.

According to examples of the apparatuses and methods disclosed herein, a method for performing scalable counters-based event detection may include receiving, at an event information collector (e.g., a host, or other such components as disclosed herein), at least one event notification from an event source of a plurality of event sources (e.g., devices, or other such components as disclosed herein). The at least one event notification may include an identification associated with the event source. The method may further include translating the at least one event notification into at least one remote atomic increment operation. The method may further include modifying, based on the at least one remote atomic increment operation, at least one counter value.

According to further examples disclosed herein, an apparatus for scalable counters-based event detection may include hardware configured to receive at least one event notification from an event source of a plurality of event sources (e.g., devices, or other such components as disclosed herein), and translate the at least one event notification into at least one remote atomic increment operation. The hardware may be further configured to modify, based on the at least one remote atomic increment operation, at least one counter value.

According to further examples disclosed herein, an apparatus for scalable counters-based event detection may include means for receiving (e.g., an input/output (I/O) block of a many-core system on a chip (SoC) as disclosed herein), at an event information collector, at least one event notification from an event source of a plurality of event sources. The at least one event notification may include an identification associated with the event source. The apparatus may further include means for translating (e.g., the I/O block of the many-core SoC as disclosed herein) the at least one event notification into at least one remote atomic increment operation. The apparatus may further include means for modifying (e.g., the I/O block of the many-core SoC as disclosed herein), based on the at least one remote atomic increment operation, at least one counter value.

According to further examples disclosed herein, a non-transitory computer-readable medium storing computer-executable instructions that, when executed by a processor, may cause the processor to receive, at an event information collector, at least one event notification from an event source of a plurality of event sources. The at least one event notification may include an identification associated with the event source. The computer-executable instructions, when executed by the I/O block, may further cause the I/O block to translate the at least one event notification into at least one remote atomic increment operation. The computer-executable instructions, when executed by the I/O block, may further cause the I/O block to modify, based on the at least one remote atomic increment operation, at least one counter value.

Other objects and advantages associated with the aspects disclosed herein will be apparent to those skilled in the art based on the accompanying drawings and detailed description.

For the apparatuses and methods disclosed herein, the elements of the apparatuses and methods disclosed herein may be any combination of hardware and programming to implement the functionalities of the respective elements. In some examples described herein, the combinations of hardware and programming may be implemented in a number of different ways. For example, the programming for the elements may be processor executable instructions stored on a non-transitory machine-readable storage medium and the hardware for the elements may include a processing resource to execute those instructions. In these examples, a computing device implementing such elements may include the machine-readable storage medium storing the instructions and the processing resource to execute the instructions, or the machine-readable storage medium may be separately stored and accessible by the computing device and the processing resource. In some examples, some elements may be implemented in circuitry.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example architectural block diagram of a scalable counters-based event detection apparatus, in accordance with an example of the present disclosure;

FIG. 2 illustrates an example architectural block diagram for processing a received ERR_COR message to illustrate operation of the scalable counters-based event detection apparatus of FIG. 1, in accordance with an example of the present disclosure;

FIG. 3 illustrates tables with a hierarchical relationship to illustrate operation of the scalable counters-based event detection apparatus of FIG. 1, in accordance with an example of the present disclosure;

FIG. 4 illustrates a block diagram of a many-core system on a chip (SoC) that supports performing scalable counters-based event detection, in accordance with an example of the present disclosure; and

FIG. 5 illustrates a flowchart of an example process associated with scalable counters-based event detection, in accordance with an example of the present disclosure.

### DETAILED DESCRIPTION

Disclosed herein are apparatuses and methods that provide scalable counters-based event detection with a limited number of hardware resources and with scalability as needed for relatively large event bursts. Events, as disclosed herein, may include correctable errors and other types of notifications transmitted from one or more devices to a host. The apparatuses and methods also provide for efficient logging of events, thus reducing the likelihood of losing event notifications due to overflow. Yet further, the apparatuses and methods provide for maintenance of precise information, such as bus, device, function, etc., about the origin of events.

The apparatuses and methods disclosed herein may utilize remote atomics, where basic event counting may be an atomic increment. In this context, atomic operations may be described as operations that operate on a value stored in a memory, register, or other structure, for example, by reading a value, modifying that value, and then writing the modified value back to the location from which is was read. This read-modify-write sequence may be performed in such a way that no other actor can affect or observe the intermediate steps, but rather, observes the value to go directly from an initial state to a modified state. A remote atomic may be described as a specific kind of atomic operation where the read-modify-write action is implemented at or near the location in which the value is stored, for example in a memory controller.

For the apparatuses and methods disclosed herein, an event notification may be translated into a remote atomic increment operation. In this regard, event counting may utilize the same counter or different counters for one or more sources (e.g., devices) of events. Remote atomics may utilize remote atomic semantics, where actual increments may occur in memory, as opposed to the point of origin. Examples of techniques for event counting may include saturating increment, various types of filters, periodic saturating decrement for leaky bucket, etc. For example, for the saturating increment, once a maximum counter value (e.g., 1111) is reached, instead of allowing for rollover, the maximum counter value may be utilized as an indicator for further processes. For the saturating decrement, once a minimum counter value (e.g., 0000) is reached, instead of allowing for rollover, the minimum counter value may be utilized as an indicator for further processes. The leaky bucket approach may specify an acceptable event rate, beyond which further events are not counted. Further, the filter approach may filter out certain events, or perform other operations to filter out events. For example, filtering may be based on a source of an event, e.g., events reported by switch downstream ports are recorded and others are ignored, or based on type, for example recording messages that report both correctable and uncorrectable errors but ignore fatal errors.

The apparatuses and methods may include indexing of a system memory data structure by a source of events. In this regard, depending on the level of specificity needed, Segment Bus-Device-Function (SBDF) identification, full Bus-Device-Function (BDF) identification, or just Bus-Device (BD), or even just Bus (B) may be utilized to index the system memory data. As disclosed herein, an event message (e.g., a correctable error) received from a device at a root port may include the SBDF, BDF, BD, or B of the device and associated function that is reporting the event. The results from the indexing may be read by software as a type of histogram.

Additional structures may be utilized to reduce the software search space when sampling a main structure that includes counter values in the system memory. For example, a bit vector may be utilized to indicate which regions of the main structure have been modified. Reduction of the software search space may eliminate regions of the main structure that have not been modified.

In order to avoid loss of event reporting while reading the system memory, software may read the system memory using atomic swap (or similar operations) to read and reset counters. The atomic swap may load the value of a register (e.g., zeros) into the memory location that included the counter value, and the register may now have the value of the memory location. Alternatively, software may read these structures by atomically moving a pointer to a buffer. This approach may be used for events within a System on Chip (SoC). This approach may also be utilized for events other than errors.

For the apparatuses and methods disclosed herein, tables may be utilized in the system memory to organize stored counter values. The tables may be single level, or include multiple levels. Use of a multi-level tables may provide for system software to read out results to focus on one part of a base address that is used to generate a remote atomic increment operation as disclosed herein. For example, a table may include a first structure that utilizes a Bus-Device-Function (BDF) value to perform a remote atomic increment operation, and a second structure that includes a different base address pointer based on a bus value. This provides for reduction of the search space related to a counter.

For the apparatuses and methods disclosed herein, any type of infrequent (but potentially bursty) events may be counted. Examples of such events may include unusual processor, cache, or interconnect events. Utilization of remote atomics and the system memory (or other types of memory) as disclosed herein provides for improved scaling and the ability to avoid and/or accurately report counter overflow.

Remote atomics may be utilized for the apparatuses and methods disclosed herein. If remote atomics are unavailable or undesirable, the apparatuses and methods may utilize a local cache, enabling local atomics to be used. The use of local atomics in this regard may provide for greater flexibility in an event report structure such as recording of timestamps or sequence pointers (e.g., pointing back to the previous different event source to simplify debugging cascades of errors).

For the apparatuses and methods disclosed herein, because lower-level event counting is offloaded by hardware rather than requiring per-event action by software, a relatively smaller core (e.g., a system management processor) may be utilized to read out a resulting data structure, e.g. a histogram table, making it unnecessary to apply the resources of a primary compute core for this purpose. Further, the smaller core may be utilized to perform additional filtering/processing and pass on telemetry to a baseboard management controller (BMC).

The apparatuses and methods disclosed herein provide advantages such as improved detection of conditions that require attention, with greater accuracy and fine-grained error source isolation, as well as isolation of affected hardware in support of rapid mitigation. Error processing may be offloaded, thus increasing the useable effective core count.

The apparatuses and methods thus provide an efficient means of collecting information about events that occur infrequently, but may occur in large bursts. In this regard, the apparatuses and methods disclosed herein, perform, in hardware, placement of such events in memory (or in another device) in a format that can be analyzed by software to determine whether a device associated with the event needs further remedial action(s) in order to restore its proper functioning. For example, the placement of such events in memory (or in another device) may be in a format such as a histogram, where any spikes in the histogram may represent an anomaly indicative of potential further remedial action(s) needed for a device. Examples of remedial actions may include resetting or shutting down a device, performing a device-specific repair operation, notifying concerned parties that a device may not be operating properly, or other actions, individually or in combination.

The apparatuses and methods disclosed herein may be applicable to all types of event notifications, including errors. Devices as disclosed herein may be physically distinct or integrated with a host, or may be part of the host. In this regard, the bus/device/function as disclosed herein are examples, but any type of identifier may be utilized, provided that the identifier is meaningful in the context of the system.

The apparatuses and methods disclosed herein may include various applications such as system DRAM errors, errors on die-to-die links, errors in internal buffers/on-chip memories, and other such events.

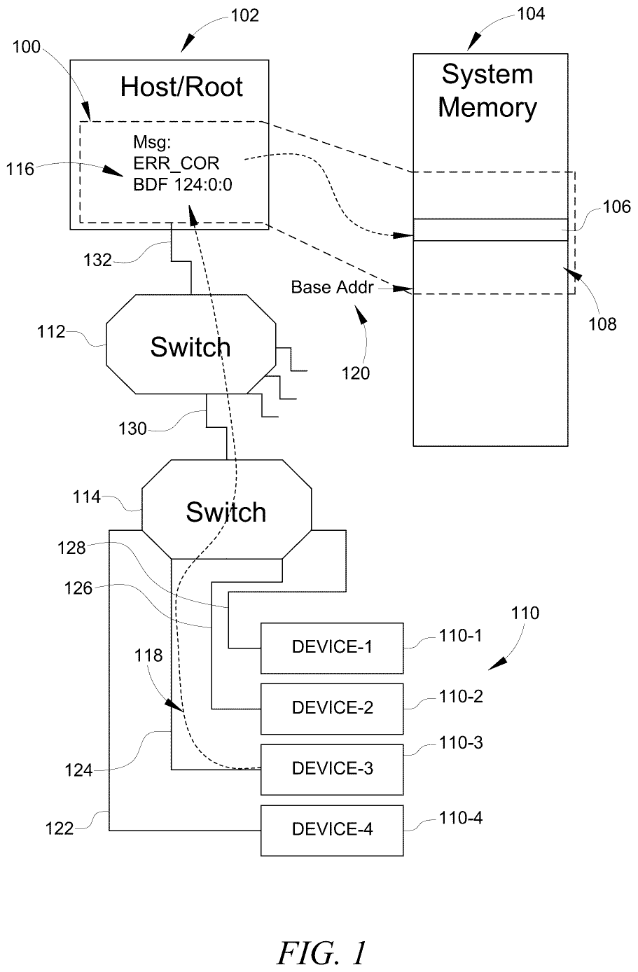

FIG. 1 illustrates an example architectural block diagram of a scalable counters-based event detection apparatus (hereinafter also referred to as “apparatus 100”), in accordance with an example of the present disclosure.

Referring to FIG. 1, the apparatus 100 is shown as being disposed within a host 102. In this regard, the host 102 may include system memory 104. For the example of FIG. 1, the system memory 104 is shown separate from the host 102 to illustrate operation of the apparatus 100, particularly with respect to translating an event notification into a remote atomic increment operation, and modifying a counter value of a counter 106 at a specified address space 108 of the system memory 104.

The host 102 may receive event notifications (e.g., error messages and other types of notifications) from devices 110 (e.g., Device-1, . . . , Device-n, where Device-1, Device-2, Device-3, and Device-4 are shown in FIG. 1). For the example of FIG. 1, the devices 110 may also be denoted 110-1, 110-2, 110-3, and 110-4. Each device may represent a multi-function device. Examples of devices may include storage devices (e.g., non-volatile memory express (NVMe) storage device), network interface cards (NIC), graphics processing unit (GPU)/Accelerator device, etc. The devices 110 may be connected to the host 102 via buses. For the example of FIG. 1, the devices 110 may be connected to the host 102 via bus 122, bus 124, bus 126, and bus 128, and intermediate switches 112 and 114. The switches 112 and 114 may be connected to the host 102 via bus 130 and bus 132. Further, the switches 112 and 114 may include additional bus connections for connection to further devices (not shown).

In one example, a function associated with each device may be uniquely identified by a triplet, which may be referred to as a BDF (e.g., bus, device and function). For example, as shown at 116, the BDF for Device-3 (e.g., device 110-3) may be represented as 124:0:0 as shown. In the example shown, the bus number may be an 8-bit field, and the device and function numbers may be 5-bit and 3-bit fields, respectively.

The apparatus 100 may receive, at the host 102, at least one event notification 118 (e.g., a correctable error message, also referred to as “ERR_COR”) from a device, where the at least one event notification may include an identification of the device. The apparatus 100 may implement logic to translate the received event notification 118 into a remote atomic increment operation. For example, the received event notification 118 may be translated into an atomic increment (e.g., base address+stride×value of BDF, for the Device-3). For the example of FIG. 1, the event notification 118 is illustrated as being transmitted from the Device-3 (e.g., device 110-3) associated with bus 124, via switches 114 and 112, and received by the apparatus 100.

The remote atomic increment operation, which includes an indication (e.g., a device identification (ID)) of origination from Device-3 (e.g., device 110-3), may be analyzed, for example, by software at a subsequent time to determine the source of the event (e.g., Device-3). Depending on the type and/or frequency of the event notifications, various further operations may be performed on the Device-3 (e.g., reboot, shutdown, etc.).

The apparatus 100 may modify, based on the remote atomic increment operation, a counter value of the counter 106 at the specified address space 108 of the system memory 104. In this regard, the event notifications received from the devices 110 may be utilized to create a histogram of received events in the system memory 104. The histogram may be analyzed by system firmware or software to determine which device(s) is reporting a relatively large number of events. In this regard, the function associated with the device may be identified as the cause of the large number of events. The system firmware or software may analyze the histogram, for example, for a spike in the histogram that represents a relatively large number of events such as errors, or for a trough in the histogram that could represent a condition resulting in an abnormally slow performing function.

If counter values are added to a bin associated with a device function, then system firmware or software may compare a number of counter values to one or more thresholds. For example, if a number of counter values for a device are below a first low threshold, this may serve as an indication that the device is to be monitored. If a number of counter values for the device are above the first low threshold but below a second high threshold, this may serve as an indication that the device is to be reset. If a number of counter values for the device are above the second high threshold, this may serve as an indication that the device is to be shut down. In this manner, one or more thresholds may be utilized to monitor or otherwise perform remedial actions related to a device.

Thus, the apparatus 100 may determine whether a counter value exceeds a threshold (e.g., counter value of 9). Further, based on a determination that the counter value exceeds the threshold, the apparatus 100 may determine an operation (e.g., restart, shut down, etc.) that is to be performed on a device.

In another example, the apparatus 100 may compare the counter value to a plurality of thresholds. Further, the apparatus 100 may select, based on the comparison of the counter value to the plurality of thresholds (e.g., counter values of 9 and 18), an operation from a plurality of operations (e.g., restart if counter value is between 9 and 17, and shut down if counter value is greater than or equal to 18) corresponding to different thresholds of the plurality of thresholds that is to be performed on the device.

With respect to translation of an event notification into a remote atomic increment operation, in one example, a BDF value may be utilized as an index from a base address 120 so that the base address 120 points to the base of the specified address space 108 of the system memory 104 that has been set aside. In this regard, counters in the system memory 104 may be specified as a particular size, e.g., 64 bits or 8 bytes. Each counter entry into the specified address space 108 may be specified as a BDF multiplied by the counter size, which may also be referred to as a stride, and added to the base address 120.

In other examples, translation of an event notification into a remote atomic increment operation may include translating, based on the base address 120 of the system memory 104 and a Segment Bus-Device-Function (SBDF) value, the BDF value, a Bus-Device (BD) value, or a Bus (B) value associated with the device, the event notification into the remote atomic increment operation.

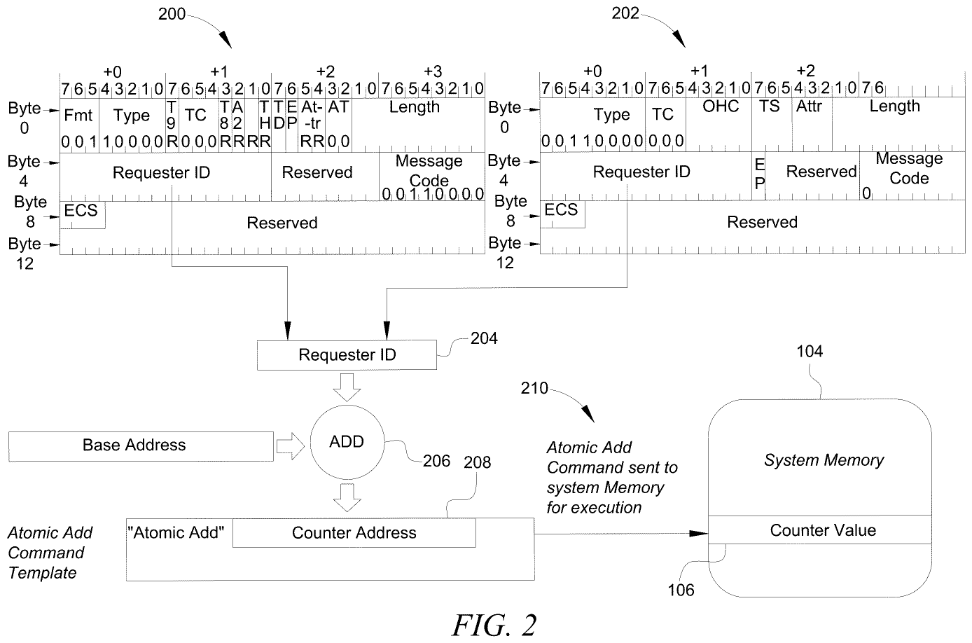

FIG. 2 illustrates an example architectural block diagram for processing a received ERR_COR message to illustrate operation of the apparatus 100, in accordance with an example of the present disclosure.

Referring to FIGS. 1 and 2, and particularly FIG. 2, a PCIe ERR_COR message from a device 110 for a non-flit mode is shown at 200 and an ERR_COR message for a flit mode is shown at 202. The non-flit mode and the flit mode may represent transaction layer packet (TLP) formats which utilize the same requester identification (ID) 204. The requester ID may represent the BDF 116 of a device as shown in FIG. 1. For the example of FIG. 2, one of the ERR_COR messages 200 or 202 may be received by the apparatus 100.

As shown by the “add” operation at 206, the apparatus 100 may receive, at the host 102, at least one event notification 118 (e.g., one of the ERR_COR messages 200 or 202) from a device, where the at least one event notification may include an identification of the device. At 208, the apparatus 100 may implement logic to translate the received event notification 118 into a remote atomic increment operation. For example, the received event notification 118 may be translated into an atomic increment (e.g., base address+stride×value of requester ID). In this regard, the requester ID added to the base address results in the counter address of an associated counter in the system memory 104.

At 210, the apparatus 100 may modify, based on the remote atomic increment operation, a counter value of the counter 106 at a specified address space of the system memory 104. For example, the counter value of the counter 106 may be incremented for a saturating increment or decremented for a saturating decrement as disclosed herein.

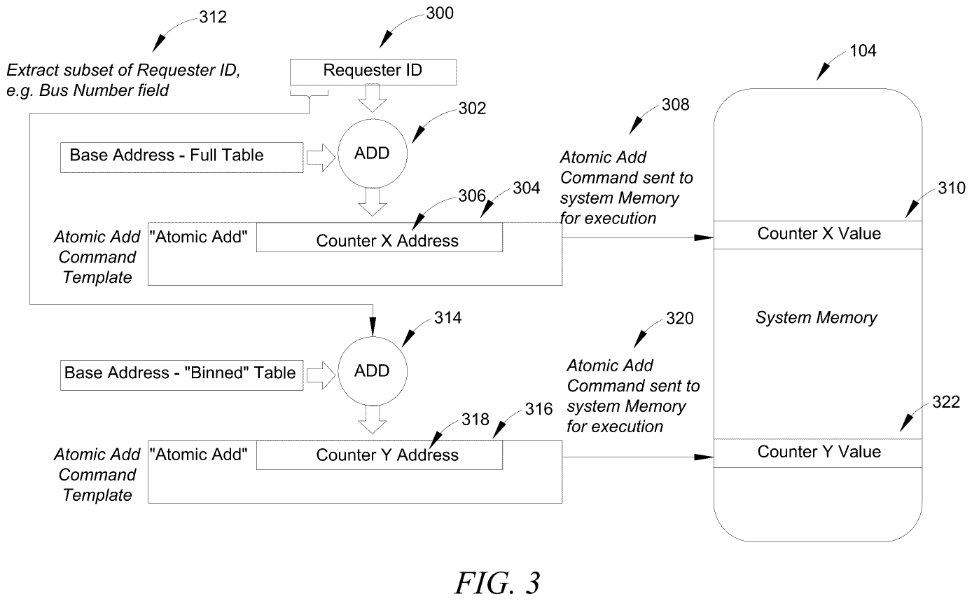

FIG. 3 illustrates tables with a hierarchical relationship to illustrate operation of the apparatus 100, in accordance with an example of the present disclosure.

Referring to FIGS. 1 and 3, and particularly FIG. 3, in some aspects, it may be desirable to make more than one record of an event, for example to record both a specific source of an event and a more general indication of a volume of events in a sub-system. In this regard, FIG. 3 shows that a requester ID 300, which represents the BDF 116 of a device as shown in FIG. 1, may be received by the apparatus 100. As shown by the “add” operation at 302, the apparatus 100 may receive, at the host 102, at least one event notification 118 from a device, where the at least one event notification may include the requester ID 300 of the device. At 304, the apparatus 100 may implement logic to translate the received event notification 118 into a remote atomic increment operation. For example, the received event notification 118 may be translated into an atomic increment (e.g., base address (full table)+(stride×value of requester ID). In this regard, the requester ID added to the base address results in the “counter X address” at 306 of an associated counter in the system memory 104.

At 308, the apparatus 100 may modify, based on the remote atomic increment operation, a counter value of a counter 310 at a specified address space of the system memory 104. For example, the counter value of the counter 310 may be incremented for a saturating increment or decremented for a saturating decrement as disclosed herein. The counter 310 may include the full value of the atomic increment (e.g., base address (full table)+stride×value of requester ID).

At 312, a subset of the requester ID (e.g., the bus number field) may be extracted from the requester ID 300. As shown by the “add” operation at 314, the apparatus 100 may receive the subset of the requester ID. At 316, the apparatus 100 may implement logic to translate the extracted subset of the requester ID for the received event notification 118 into a remote atomic increment operation. For example, the extracted subset of the requester ID for the received event notification 118 may be translated into an atomic increment (e.g., base address (binned table)+stride×extracted subset of requester ID). In this regard, the extracted subset of the requester ID added to the base address results in the “counter Y address” at 318 of an associated counter in the system memory 104.

At 320, the apparatus 100 may modify, based on the remote atomic increment operation, a counter value of a counter 322 at a specified address space of the system memory 104. For example, the counter value of the counter 322 may be incremented for a saturating increment or decremented for a saturating decrement as disclosed herein. The counter 322 may include the binned value of the atomic increment (e.g., base address (binned table)+stride×extracted subset of requester ID).

Compared to the counter 310 that utilizes the “counter X address” at 306, the counter 322 that utilizes the “counter Y address” at 318 may provide information related to a device associated with the bus number field, as opposed to details related to specific functions performed by the device. In this regard, the limited information related to the device provided by the “counter Y address” at 318 may be utilized for further remedial actions related to the device (e.g., reset, shut-down, etc.), as opposed potential additional remedial actions related to specific functions performed by the device.

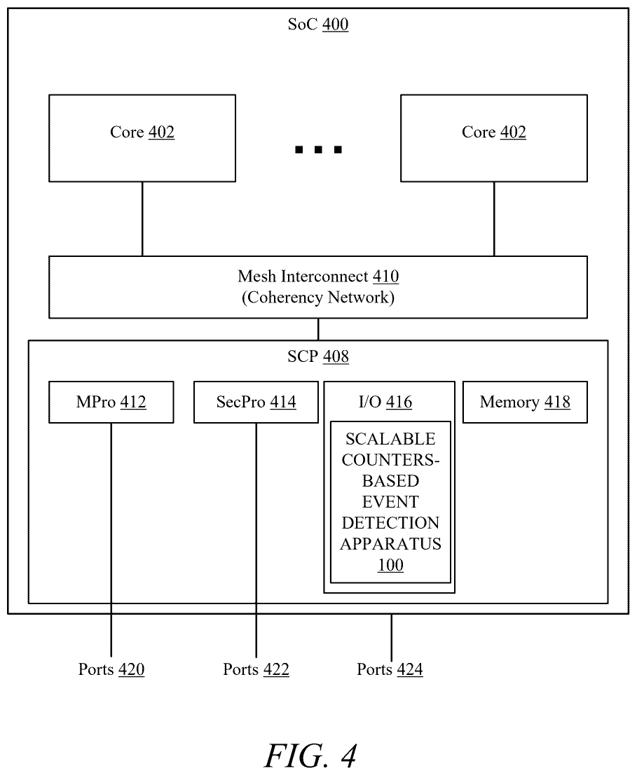

FIG. 4 illustrates a block diagram of a many-core system on a chip (SoC) 400 that supports performing scalable counters-based event detection, in accordance with an example of the present disclosure.

In the example of FIG. 4, an input/output (I/O) block 416, which is described in further detail below, may include the apparatus 100. However, the apparatus 100 may likewise be included in other blocks of the SoC 400.

The SoC 400 may include a set of processing cores 402 (or simply “cores” 402).

The SoC 400 also includes a system control processor (SCP) 408 that handles many of the system management functions of the SoC 400. The cores 402 are connected to the SCP 408 via a mesh interconnect 410 that forms a high-speed bus that couples each of the cores 402 to the other cores 402 and to other on chip and off-chip resources, including higher levels of memory (e.g., a level three (L3) cache, dual data rate (DDR) memory), peripheral component interconnect express (PCIe) interfaces, and/or other resources.

The SCP 408 may include a variety of system management functions, which may be divided across multiple functional blocks, or which may be contained in a single functional block. In the example illustrated in FIG. 4, the system management functions of the SCP 408 are divided over a management processor (MPro) 412 and a security processor (SecPro) 414 coupled to other components of the SoC 400 by the mesh interconnect 410. The SoC 400, the MPro 412, and the SecPro 414 may each include joint test action group (JTAG) ports and firmware, which may be connected to other components within the SoC 400 via the mesh interconnect 410, an inter-integrated circuit (I2C) interface, or other connection. In the example illustrated in FIG. 4, the SCP 408 further includes the input/output (I/O) block 416 and an on-board shared memory 418 also coupled to other components of the SoC 400 by the mesh interconnect 410. Note that although FIG. 4 illustrates the MPro 412 and the SecPro 414 as separate microcontrollers (or processors), as will be appreciated, they may be combined into one or two microcontrollers, or sub-divided into more than two microcontrollers.

The MPro 412 and the SecPro 414 may include a bootstrap controller and an I2C controller or other bus controller. The MPro 412 and the SecPro 414 may communicate with on-chip sensors, an off-chip baseboard management controller (BMC), and/or other external systems to provide control signals to external systems. The MPro 412 and the SecPro 414 may connect to one or more off-chip systems as well via ports 420 and ports 422, respectively, and/or may connect to off-chip systems via the I/O block 416, e.g., via ports 424.

In some aspects, the MPro 412 (or a processor having similar functions) may be utilized to perform some or all of the methods disclosed herein. The MPro 412 performs error handling and crash recovery for the cores 402 of the SoC 400 and performs power failure detection, recovery, and other fail safes for the SoC 400. The MPro 412 performs the power management for the SoC 400 and may connect to one or more voltage regulators (VR) that provide power to the SoC 400. The MPro 412 may receive voltage readings, power readings, and/or thermal readings and may generate control signals (e.g., dynamic voltage and frequency scaling (DVFS)) to be sent to the voltage regulators. The MPro 412 may also report power conditions and throttling to an operating system (OS) or hypervisor running on the SoC 400. The MPro 412 may provide the power for boot up and may have specific power throttling and specific power connections for boot power to the SCP 408 and/or the SecPro 414. The MPro 412 may receive power or control signals, voltage ramp signals, and other power control from other components of the SCP 408, such as the SecPro 414, during boot up as hardware and firmware become activated on the SoC 400. These power-up processes and power sequencing may be automatic or may be linked to events occurring at or detected by the MPro 412 and/or the SecPro 414. The MPro 412 may connect to the shared memory 418, the SecPro 414, and external systems (e.g., VRs) via ports 420, and may supply power to each via power lines. In some aspects, the MPro 412 is the entity on which firmware resides.

The SecPro 414 manages the boot process and may include on-board read-only memory (ROM) or erasable programmable ROM (EPROM) for safely storing firmware for controlling and performing the boot process. The SecPro 414 also performs security sensitive operations and runs authenticated firmware. More specifically, the components of the SoC 400 may be divided into trusted components and non-trusted components, where the trusted components may be verified by certificates in the case of software and firmware components, or may be pure hardware components, so that at boot time, the SecPro 414 may ensure that the boot process is secure.

The shared memory 418 may be on-board random-access memory (RAM) or secured RAM that can be trusted by the SecPro 414 after an integrity check or certificate check. The I/O block 416 may connect over ports 424 to external systems and memory (not shown) and connect to the shared memory 418. The SCP 408 may use the I/O connections of the I/O block 416 to interface with a BMC or other management system(s) for the SoC 400 and/or to the network of the cloud platform (e.g., via gigabit ethernet, PCIe, or fiber). The SCP 408 may perform scaling, balancing, throttling, and other control processes to manage the cores 402, associated memory controllers, and mesh interconnect 410 of the SoC 400.

In some aspects, the mesh interconnect 410 is part of a coherency network. There are points of coherency somewhere in the mesh network depending on the address and target memory. A coherency network typically includes control registers, status registers, and state machines, and in the example illustrated in FIG. 4, these are initialized by the MPro 412, e.g., based on system and memory configuration, and the MPro 412 monitors the coherency domain for errors.

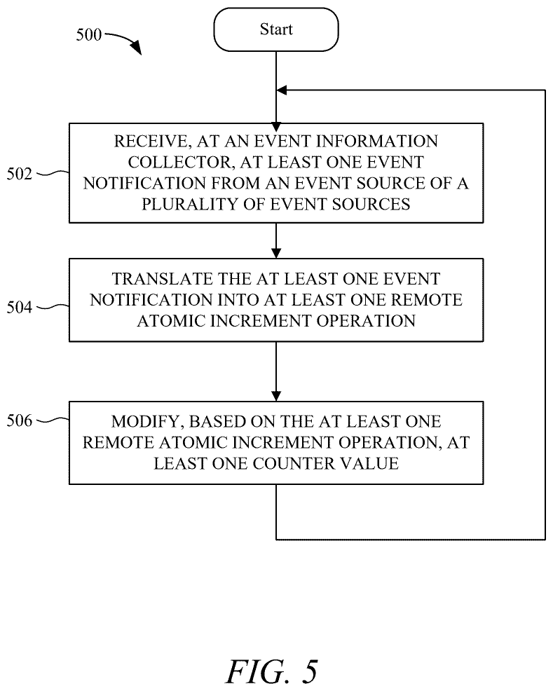

FIG. 5 illustrates a flowchart of an example process 500 associated with scalable counters-based event detection, in accordance with an example of the present disclosure. In some implementations, one or more process blocks of FIG. 5 may be performed by one or more components of an SoC, such as processor(s), memory, or other circuitry, any or all of which may be means for performing the operations of process 500. For example, in some aspects, one or more process blocks of FIG. 5 may be performed by control circuitry for an SoC (e.g., the SoC 400). As shown in FIG. 5, process 500 may periodically perform an operation configuration. In the example shown in FIG. 5, an operation configuration includes the following steps.

Process 500 may include, at block 502, receiving, at an event information collector (e.g., a host, or other such components as disclosed herein), at least one event notification from an event source of a plurality of event sources (e.g., devices, or other such components as disclosed herein). In this regard, the at least one event notification may include an identification of the device. For example, with reference to FIGS. 1 and 5, the host 102 may receive event notifications (e.g., error messages and other types of notifications) from devices 110 (e.g., Device-1, ..., Device-n, where Device-1, Device-2, Device-3, and Device-4 are shown in FIG. 1, and also denoted 110-1, 110-2, 110-3, and 110-4). In the example of FIG. 1, a function associated with each device may be uniquely identified by a triplet, which may be referred to as the BDF, where the BDF for Device-3 (e.g., device 110-3) may be represented as 124:0:0 as shown.

Process 500 may further include, at block 504, translating the at least one event notification into at least one remote atomic increment operation. In some aspects, translating the at least one event notification into the at least one remote atomic increment operation may include translating, based on a base address of the memory and a Segment Bus-Device-Function (SBDF) value, a Bus-Device-Function (BDF) value, a Bus-Device (BD) value, or a Bus (B) value associated with the device, the at least one event notification into the at least one remote atomic increment operation. For example, with reference to FIGS. 1 and 5, the received event notification 118 may be translated into an atomic increment (e.g., base address+stride×value of BDF, for the Device-3). For the example of FIG. 1, the event notification 118 is illustrated as being transmitted from the Device-3 (e.g., device 110-3) associated with bus 124, via switches 114 and 112, and received by the apparatus 100.

Process 500 may further include, at block 506, modifying, based on the at least one remote atomic increment operation, at least one counter value. For example, with reference to FIGS. 1 and 5, the event notifications received from the devices 110 may be utilized to create a histogram of received events in the system memory 104. The histogram may be analyzed by system firmware or software to determine which device(s) is reporting a relatively large number of events. In this regard, the function associated with the device may be identified as the cause of the large number of events. The system firmware or software may analyze the histogram, for example, for a spike in the histogram that represents a relatively large number of events such as errors, or for a trough in the histogram that could represent a condition resulting in an abnormally slow performing function. If counter values are added to a bin associated with a device function, then system firmware or software may compare a number of counter values to one or more thresholds. In some aspects, modifying, based on the remote atomic increment operation, the counter value at the specified address space of the memory may include incrementing, based on the remote atomic increment operation, the counter value as a saturating increment at the specified address space of the memory, or decrementing, based on the remote atomic increment operation, the counter value as a saturating decrement at the specified address space of the memory. For example, for the saturating increment, once a maximum counter value (e.g., 1111) is reached, instead of allowing for rollover, the maximum counter value may be utilized as an indicator for further processes. For the saturating decrement, once a minimum counter value (e.g., 0000) is reached, instead of allowing for rollover, the minimum counter value may be utilized as an indicator for further processes.

Process 500 may include additional implementations, such as any single implementation or any combination of implementations described in connection with one or more other processes described elsewhere herein. Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects). Furthermore, it is also intended that aspects of a clause can be included in any other independent clause, even if the clause is not directly dependent on the independent clause.

It will be understood that the specific implementations described herein are illustrative and not limiting. The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein but is to be accorded the widest scope consistent with the principles and novel features disclosed herein.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art.

Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art will further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application-specific integrated circuit (ASIC), a field-programmable gate array (FPGA), or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method for scalable counters-based event detection, the method comprising:
receiving, at an event information collector, at least one event notification from an event source of a plurality of event sources, wherein the at least one event notification includes an identification associated with the event source;
translating the at least one event notification into at least one remote atomic increment operation; and
modifying, based on the at least one remote atomic increment operation, at least one counter value.

2. The method of claim 1, modifying, based on the at least one remote atomic increment operation, the at least one counter value further comprises:
modifying, based on the at least one remote atomic increment operation, the at least one counter value at a specified address space of memory.

3. The method of claim 2, further comprising:
translating a portion of the at least one event notification into at least one further remote atomic increment operation; and
modifying, based on the at least one further remote atomic increment operation, a further counter value at a further specified address space of the memory.

4. The method of claim 1, wherein the identification associated with the event source includes an identification of the event source.

5. The method of claim 1, wherein translating the at least one event notification into the at least one remote atomic increment operation further comprises:
translating, based on a base address of memory that stores the at least one counter value and a Segment Bus-Device-Function (SBDF) value, a Bus-Device-Function (BDF) value, a Bus-Device (BD) value, or a Bus (B) value associated with the event source, the at least one event notification into the at least one remote atomic increment operation.

6. The method of claim 1, wherein the at least one event notification includes at least one correctable error notification.

7. The method of claim 1, wherein modifying, based on the at least one remote atomic increment operation, the at least one counter value further comprises:
incrementing, based on the remote atomic increment operation, the counter value as a saturating increment.

8. The method of claim 1, wherein modifying, based on the at least one remote atomic increment operation, the at least one counter value further comprises:
decrementing, based on the remote atomic increment operation, the counter value as a saturating decrement.

9. The method of claim 1, further comprising:
determining whether the at least one counter value exceeds a threshold; and
based on a determination that the at least one counter value exceeds the threshold, determining an operation that is to be performed on the event source.

10. The method of claim 1, further comprising:
comparing the at least one counter value to a plurality of thresholds; and
selecting, based on the comparison of the at least one counter value to the plurality of thresholds, an operation from a plurality of operations corresponding to different thresholds of the plurality of thresholds that is to be performed on the event source.

11. The method of claim 1, further comprising:
determining, based on a bit vector, a region of memory that is modified.

12. The method of claim 1, further comprising:
utilizing an atomic swap to read the at least one counter value and to reset a counter associated with the at least one counter value.

13. An apparatus for scalable counters-based event detection, the apparatus comprising:
hardware configured to:
receive at least one event notification from an event source of a plurality of event sources;
translate the at least one event notification into at least one remote atomic increment operation; and
modify, based on the at least one remote atomic increment operation, at least one counter value.

14. The apparatus of claim 13, wherein to translate the at least one event notification into the at least one remote atomic increment operation, the hardware is further configured to:
translate, based on a base address of memory that stores the at least one counter value and a Segment Bus-Device-Function (SBDF) value, a Bus-Device-Function (BDF) value, a Bus-Device (BD) value, or a Bus (B) value associated with the event source, the at least one event notification into the at least one remote atomic increment operation.

15. The apparatus of claim 13, wherein the at least one event notification includes at least one correctable error notification.

16. The apparatus of claim 13, wherein to modify, based on the at least one remote atomic increment operation, the at least one counter value, the hardware is further configured to:
increment, based on the at least one remote atomic increment operation, the at least one counter value as a saturating increment at a specified address space of memory.

17. The apparatus of claim 13, wherein to modify, based on the at least one remote atomic increment operation, the at least one counter value, the hardware is further configured to:
decrement, based on the at least one remote atomic increment operation, the at least one counter value as a saturating decrement at a specified address space of memory.

18. The apparatus of claim 13, wherein the hardware is further configured to:
translate a portion of the at least one event notification into at least one further remote atomic increment operation; and
modify, based on the at least one further remote atomic increment operation, at least one further counter value.

19. An apparatus for scalable counters-based event detection, the apparatus comprising:
means for receiving, at an event information collector, at least one event notification from an event source of a plurality of event sources, wherein the at least one event notification includes an identification associated with the event source;
means for translating the at least one event notification into at least one remote atomic increment operation; and
means for modifying, based on the at least one remote atomic increment operation, at least one counter value.

20. A non-transitory computer-readable medium storing computer-executable instructions that, when executed by a processor, cause the processor to:
receive, at an event information collector, at least one event notification from an event source of a plurality of event sources, wherein the at least one event notification includes an identification associated with the event source;
translate the at least one event notification into at least one remote atomic increment operation; and
modify, based on the at least one remote atomic increment operation, at least one counter value.
